(19) United States
(12) Patent Application Publication
(10) Pub. No.: US 2015/0200880 A1
(43) Pub. Date: Jul. 16, 2015

(54) METHOD AND SYSTEM OF PROVIDING A NOTIFICATION

(71) Applicant: ChaCha Search, Inc, Carmel, IN (US)

(72) Inventors: Terrence McKenna Kunstek, Indianapolis, IN (US); Scott A. Jones, Carmel, IN (US); Vee Lee, Carmel, IN (US); Eugene M O'Donnell, Fishers, IN (US)

(21) Appl. No.: 14/594,724

(22) Filed: Jan. 12, 2015

Related U.S. Application Data
(60) Provisional application No. 61/925,992, filed on Jan. 10, 2014.
(60) Provisional application No. 61/927,370, filed on Jan. 14, 2014.

(51) Int. Cl. H04L 12/58

(52) U.S. Cl. CPC H04L 51/046

(57) ABSTRACT

A system and method of providing a notification responsive to an event using visual modulation of a user interface is described. Visual modulation may be used to indicate a type of event, a number of events, a source of an event, etc. Visual modulation may include displacement, rotation, distortion, etc. of a UI or component thereof and may be accompanied by audible and/or haptic modulation which may mimic an action of a person.

### BACKGROUND

1. Field of the Invention

The present invention is related to providing a notification of an event to a user of a device and more specifically to providing a visual notification of an event.

2. Description of the Related Art

In many types of applications it may be desirable to notify a user when an event occurs. In particular if an event is time critical, a user may wish to be notified of the event. Current methods of providing a notification to a person take many forms. If a person is using a particular application or “in-App” a notification may be presenter as a pop-up or pop-over or other text based notification which appears in a user interface currently being viewed by a user. If a user is currently using the app a peripheral indicator may also be used to signify that an event or a number of events has occurred. For example an Icon may be presented which may include a count indicator which identifies a type and a number of events which have been observed. Activation of such an icon or notification may cause a user to be directed to the App or another location based on the notification action.

Similarly if a user is not logged in or “out of App” other forms of notification such as are used in-App may be provided. Notifications may be sonic (audible or haptic), visual and/or a combination thereof. Notifications may be persisted in indications such as icons in a notification area in the borders of a Graphical User Interface (GUI) as practiced in the Android® and iOS® operating systems.

However current notification methods and systems may have weaknesses as well. A user may find frequent notifications annoying. Notification indicators consume valuable screen space, especially on small screens such as those of mobile devices. Sonic notifications may be disturbing to a user or others and may be suppressed unintentionally.

For these and other reasons a method and system for visual notifications would be greatly appreciated.

### SUMMARY

A system is implemented whereby a graphical user interface (GUI) of a device may be modulated based on the presence or absence of a notification condition. When an action or event which requires a notification of a user occurs, the GUI is spatially modulated to provide a notification. For example, a notification might cause a GUI to be shifted horizontally and/or vertically and/or might cause a distortion of the geometry of a GUI such as trapezoidal, skew, rotation, trigonometric distortion, etc. A notification may include a temporal modulation component. For example a GUI might be translated a particular distance for a particular time and then return to its original location.

While the entirely of a GUI may be modulated any element of a GUI might also be visually modulated to indicate a notification. An indication of a number of notifications and/or type of notification might be provided based on spatial and/or temporal modulation of a GUI or GUI element. For example a GUI might not return to a GUI's original location, but might be translated proportional to a number of notification events. A type of event might be indicated by a spatial or temporal modulation. For example a first type of event might cause motion vertically while a second type of event might cause motion horizontally. Such movements might be proportional to a number of events, might have a residual displacement, etc. which might indicate a number and type of events. Such residual distortions might be removed when a notification is acknowledged.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 is a flowchart of creating a condition for a notification.

FIG. 3 is a flowchart of performing visual modulation of a GUI.

FIG. 4 depicts an exemplary embodiment of modulation a GUI.

FIG. 5 is a block diagram of an exemplary system embodiment.

FIG. 6 is a flowchart of creating a request and response group.

FIG. 7 is a flowchart of providing a request and response group to a viewer.

FIG. 8 is an exemplary Graphical User Interface (GUI) for submission of a request.

FIG. 9 is an exemplary GUI for presentation of request related information.

FIG. 10 is an exemplary GUI for viewing of request related information.

FIG. 11 is an exemplary GUI for submitting a response to a request.

FIG. 12 is an exemplary GUI for an alternate presentation of request related information.

FIG. 13 is an exemplary GUI for a user-based presentation of request information.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

A system is provided which includes one or more user devices and may comprise a distribution server. A user device may be any type of computing device which may comprise a display device. A distribution server may receive requests from user devices and may detection conditions for which a user device has been configured to receive a notification.

As used herein, a “request” or query or question means a request for information, products, and/or services. A request or query may include various types of media, and may be provided by any system or device which may establish communication with a server and/or other devices accessible via a network such as the internet, a private network and/or a combination thereof.

A “user” is a person who submits a request and may receive any type of information responsive to a request. A user may be any person or entity. A “responder” or answerer may be any person or entity who elects to receive a request and provide a response.

A responder may receive requests in various ways. A responder may elect to receive requests based on one or more categories, keywords or topics assigned to a responder. Profile information associated with a responder may be used to determine when a request is directed to a responder. A ranking of a responder may affect whether a request is directed to a responder. An editor may select a responder to whom a request is directed.

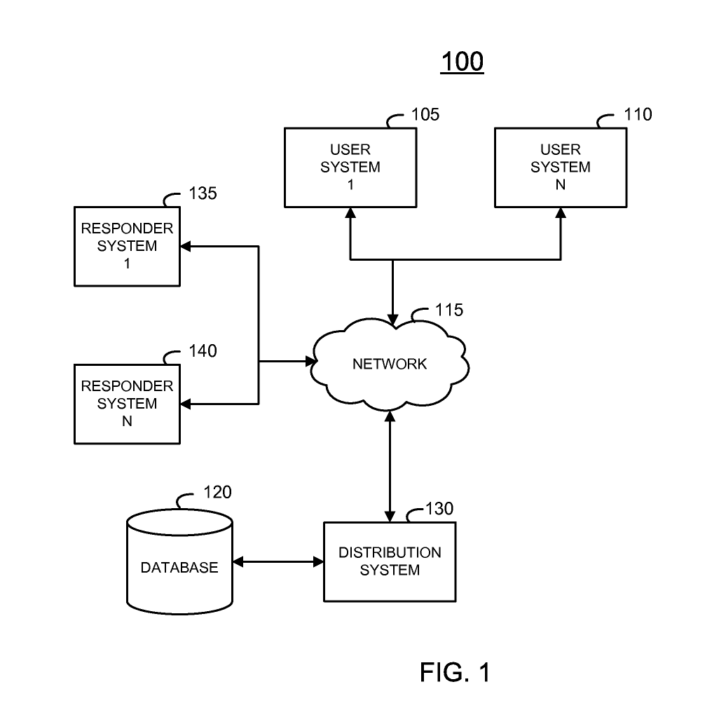

As illustrated in FIG. 1, system 100 includes user systems 105, 110, a network 115 such as the Internet, a distribution system 130, a database 120, which may comprise various records, and responder systems 135, 140. A user system and/or a responder system may be operated by a user.

While only a few systems associated with a user, a responder and a distribution system are depicted in FIG. 1 it is within the scope of the disclosure for multiple systems for a user, a responder and a distribution service to be utilized. In particular it is envisioned that many user, responder and distribution systems may be implemented. The distribution system 130 may be a composed of many components as described further herein.

The network 115 may be a global public network of networks (i.e., the Internet) and/or may consist in whole or in part of one or more private networks and communicatively couples the user systems 105, 110, and the responder systems 135, 140 with the other components of the system 100 such as the distribution system 130, and the database 120. The network 115 may include one or more wireless networks which may enable wireless communication between the various elements of the system 100. For example, the distribution system 130 may receive messages which may be routed via a wireless network controlled by a wireless service to the user systems 105, 110. A wireless service may receive messages from the responder systems 135, 140 via a wireless network which is a part of the network 115, and provide the messages to the distribution system 130 via an internet connection which is part of the network 115.

The distribution system 130 allows interaction to occur among the user systems 105, 110, and the responder systems 135, 140. For example, a request can be transmitted from the user system 105 to the distribution system 130, which may provide information obtained from the database 120, which may include an advertisement to the responder system 145. Any type of communication between users, and responders may be mediated and/or facilitated by the distribution system 130, and/or other elements of the system 100.

The distribution system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the distribution system 130. Further, the records maintained in the database 120 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any or the entirety of the database 120.

The user systems 105, 110, and the responder systems 135, 140 and the distribution system 130 may include equipment, software, systems and personnel required to send and/or receive messages between user systems 105, 110, the responder systems 135, 140 and/or the distribution system 130 using the network 115. The database 120 includes information which may allow the distribution system 130 to establish communication between any or all of the elements of the system 100.

A user system, a responder system and/or a distribution system may be a desktop, portable, or tablet computer using an operating system such as Windows®, iOS®, Android®, etc., a mobile phone, a smart phone, a PDA, a server system, a landline phone, a specialized communication terminal, a terminal connected to a mainframe, or any other suitable communication hardware and/or system. The distribution system 130, a user system and/or a responder system may include one or more servers, computers, etc. For example, servers such as the PowerEdge® 2900 by Dell, or the BladeCenterJS22 by IBM, or equivalent systems might be used to implement elements of the distribution system 130. The distribution system 130 may utilize an operating system (OS) such as Microsoft Windows XP, Linux, iOS®, Android®, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, responder systems and/or to implement the distribution system 130.

A user may be identified by the distribution system 130. When a user system accesses the distribution system 130 the user may be identified based on security information provided to the distribution system 130. A user may obtain information regarding conditions for obtaining a notification. A user may receive responses based on a number of requests composed by a user.

A user may be required to register with the distribution system 130. As part of a registration process, at least one communication method is associated with a user. In at least one embodiment, a user may register with the distribution system 130 and establish a username and password which are associated with the user. A user may login to the distribution system 130 using a web browser functionality of the user system 110 in order to communicate with the distribution system 130. One or more identifiers may be assigned to a user and may be used to identify content such as requests, responses, opinions, etc., associated with a user. A user may provide profile information such as personal information, geographic, background, affiliation, demographic, interest, category, etc. information. A user may provide information required to provide payment. A user may register using a Single Sign On (SSO) facility such as credentials from a distribution system such as a server device associated with the Facebook® or LinkedIn® services. Profile information such as communication information, personal data, etc. may be obtained based on a user sign-in credential, and/or content of a user system.

A responder may be required to register with the distribution system 130. As part of a registration process, at least one communication method is associated with a responder. In at least one embodiment, a responder may register with the distribution system 130 and establish a username and password which are associated with the responder. A responder may login to the distribution system 130 using a web browser functionality of the responder system 145 in order to communicate with the distribution system 130. One or more identifiers may be assigned to a responder and may be used to identify content associated with a responder. A responder may provide profile information such as personal information, geographic, background, affiliation, demographic, interest, category, etc. information. A request may be directed to a responder based on any information associated with a responder. A responder may elect to block requests based on factors such as content, originator, etc. A responder may provide information required to provide payment to a responder.

When a responder is registered with the distribution system 130 the responder may have access to content available from the distribution system 130. This may include sponsored content provided by advertisers, requests, response, data indicated in the database 120, requests of users, topics, etc. A responder may have access privileges based on factors such as experience of the responder, ratings of responses of a responder, revenue obtained based on works of a responder, etc. A responder may determine a condition which initiates a notification.

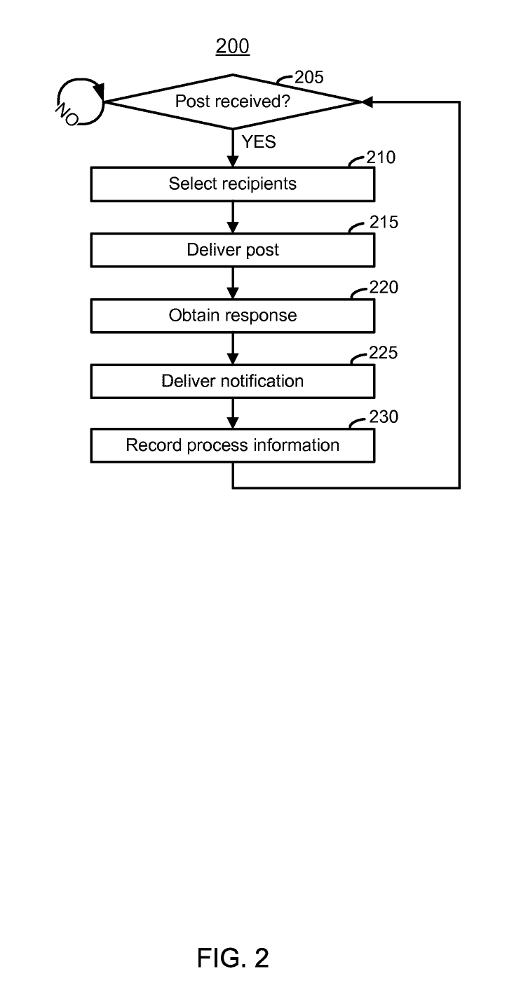

As illustrated in FIG. 2, a process 200 for creating a condition for a notification is provided. The process 200 may be performed in whole or in part by any suitable element of the system 100 (FIG. 1). In at least one embodiment, the process 200 is operative on a server associated with the distributor system 130 and/or the user device 110.

In operation 205 (FIG. 2) a determination is made as to whether a post or message or item is received. If it is determined in operation 205 that a post is not received, control remains at operation 205 and process 200 continues. If it is determined in operation 205 that a post is received, control is passed to operation 210 and process 200 continues.

The determination in operation 205 may be made using various criteria. In at least one embodiment, if a message is received at a system associated with the distribution system 130 (FIG. 1), it may be determined that a post is received. For example, if a GET request indicating an identifier of a user is received at a server associated with the distribution system 130, it may be determined that a post is received. Any type of message may be received which may indicate that a post is received. For example, reception of an SMS message, a mobile web message, a message from an App, etc., may be used to determine whether a post is received. A post may be internal to a user device. For example, if a user sets a time or a condition which may be detected based on information provided by a user device, it may be determined that a post is received.

In operation 210 recipients are selected. Recipients may be selected on any suitable basis. In an embodiment, a recipient may be a responder selected based on a posting, information of a user, information of a responder, etc. Control is passed to operation 215 and process 200 continues.

In operation 215, a post is delivered. A post may be delivered using any communication service associated with a responder. A post may be delivered using a real-time communication service such as Instant Messaging (IM), SMS, voice, email, peer-to-peer, etc. A post may be delivered to any number of responders. A post may be delivered to a selected group of responders. A post may be delivered to no responders. Control is passed to operation 220 and process 200 continues.

In operation 220 a response is obtained. A response may include any type of event or information. A response may be any event which might activate a notification. More than one response may be received. Control is passed to operation 225 and process 200 continues.

In operation 225 a notification is delivered. A notification may be delivered when a user is using an app which has caused the notification, using an app which did not cause the notification, and/or is inactive. A notification may indicate any number of events. Control is passed to operation 230 and process 200 continues.

In operation 230, process information is recorded. Information of a request, a user, a responder, a publisher, a website, an advertiser, content, targeting parameters, user actions, compensation of a publisher, responder, editor, advertiser, etc., a rating, a ranking, etc. may be recorded. In at least one embodiment, process information is recorded in the database 120 (FIG. 1). Control is passed to operation 205 and process 200 continues.

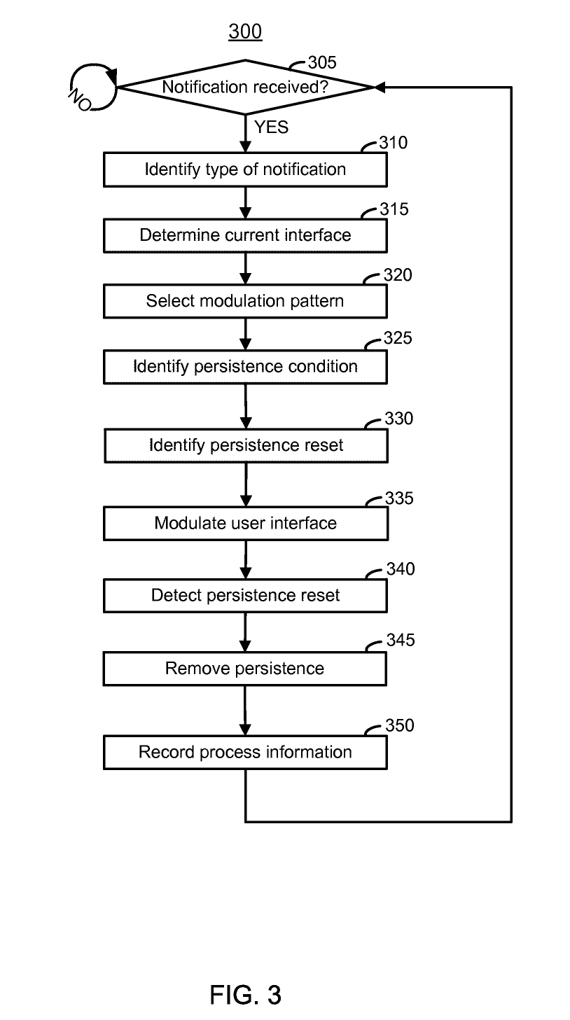

As illustrated in FIG. 3, a process 300 for providing a notification is provided. The process 300 may be performed in whole or in part by any suitable element of the system 100 (FIG. 1). In at least one embodiment, the process 300 is operative on the user device 110.

In operation 305 (FIG. 3) a determination is made as to whether a notification is received. If it is determined in operation 305 that a notification is not received, control remains at operation 305 and process 300 continues. If it is determined in operation 305 that a notification is received, control is passed to operation 310 and process 300 continues.

The determination in operation 305 may be made using various criteria. In at least one embodiment, if a message is received at a system associated with the distribution system 130 (FIG. 1), it may be determined that a notification is received. For example, if a GET request indicating an identifier of a user is received at a server associated with the distribution system 130, it may be determined that a notification is received. Any type of message may be received which may indicate that a notification is received. For example, reception of an SMS message, a mobile web message, a message from an App, etc., may be used to determine whether a notification is received. A notification may be internal to a user device. For example, if a user sets a time or a condition which may be detected based on information provided by a user device, it may be determined that a notification is received. Receipt of a “push” message from a device associated with the distribution system 130 (FIG. 1) may indicate that a notification is received.

In operation 310 notification type is identified. Any type of notification event may be received. Any number of notification types may be used. A notification type may designate various components and timings of a notification. A notification type may be used to determine when a notification will be provided, and which user selections may apply to a notification. A notification type may determine which type of notification is given based on a current user activity. Control is passed to operation 315 and process 300 continues.

In operation 315 a current interface is determined. A current interface may include a home page provided when a user device is not directed to a particular task such as a ‘desktop’ or ‘home screen’ of an OS. A current interface may be a GUI of an app which generated a condition for a notification (i.e., “in-App”). A current interface may be a GUI of an app which did not generate a condition for a notification (i.e., “out-of-App”). Control is passed to operation 320 and process 300 continues.

In operation 320, a modulation pattern is selected. A modulation pattern may be determined based on a current interface, a type of notification, a user setting, etc. A modulation pattern may be selected which indicates a particular notification. For example, if audio notifications are suppressed a corresponding visual modulation pattern may be selected. A modulation pattern may represent a type of response. For example a positive response might produce a vertical modulation, while a negative response might produce a horizontal modulation. A modulation pattern may affect a specific feature of an interface and/or an entire interface. A modulation pattern may be any suitable function or combination thereof. Control is passed to operation 325 and process 300 continues.

In operation 325 a persistence condition is identified. A persistence condition may be any indicator of a notification which remains after a notification is delivered. For example, if a notification is a time varying vertical displacement of a UI, the UI may be displaced vertically to indicate that a notification has occurred. An amount of displacement might indicate a number of notifications which have occurred. In some instances a notification may not include a persistence condition. Control is passed to operation 330 and process 300 continues.

In operation 330 a persistence reset is identified. A persistence reset may be any action which may cause a persistence condition to be removed. For example, if a user views items which generate a notification, a persistence condition may be reset or if a user ‘shakes’ a device a persistence condition may be reset. Any suitable action or event or condition may serve as a persistence reset. Control is passed to operation 335 and process 300 continues.

In operation 335 a user interface is modulated. A modulation of a user interface may take any suitable form. User interface modulation may include visual and/or audible modulation. Modulation may be static and/or temporal. A modulation pattern may indicate multiple events. A modulation pattern may represent a response to a question. If a person expresses a positive opinion of a question, response, and/or other posting, a notification modulation pattern may indicate the positive opinion by a visual vibration. If a person adds a hashtag, such as “#joke” or “#LOL” to a response, a modulation pattern may indicate laughter, which might be accompanied by an audible and/or haptic element. Control is passed to operation 340 and process 300 continues.

In operation 340 a persistence reset is detected. If a user action or other condition identified as a persistence reset occurs a persistent indicator may be removed. For example, if a user views a response, an opinion, etc. a persistence reset may be detected. Control is passed to operation 345 and process 300 continues.

In operation 345 a persistence feature is removed. For example, if a geometric offset, a numeric indicator, an icon, etc. which is associated with a detected persistence reset is identified an associated persistence feature may be removed. Control is passed to operation 350 and process 300 continues.

In operation 350, process information is recorded. Information of a request, a user, a responder, a publisher, a website, an advertiser, content, targeting parameters, user actions, etc., a rating, a ranking, etc. of an item may be recorded or persisted. In at least one embodiment, process information is recorded in the database 120 (FIG. 1). Control is passed to operation 305 and process 300 continues.

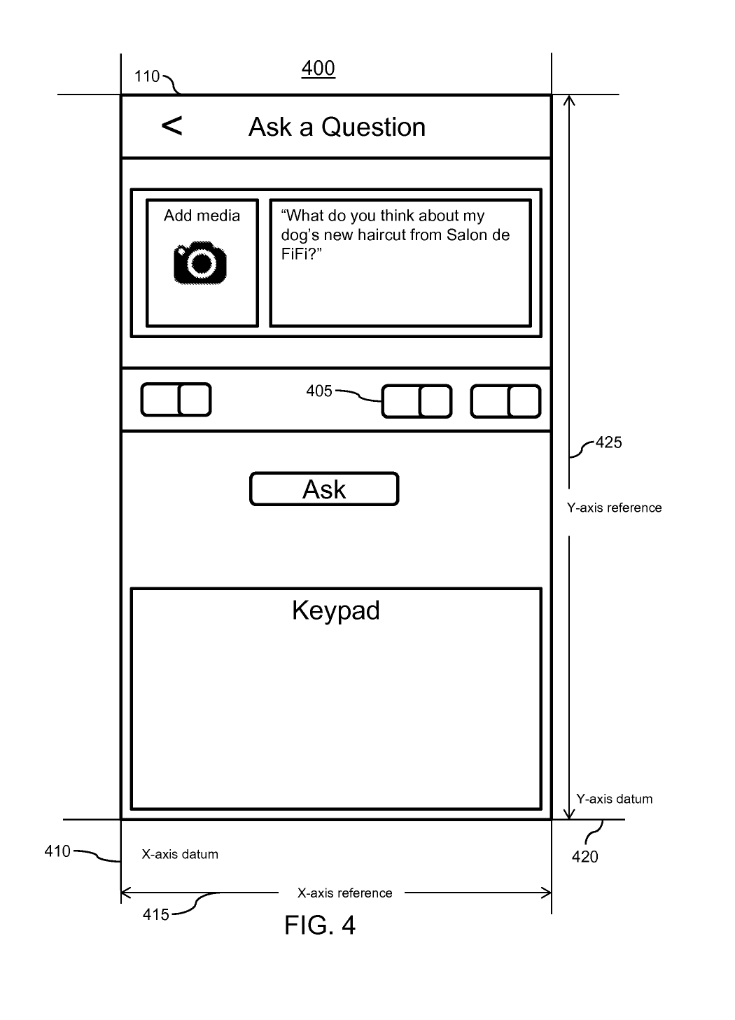

An exemplary User Interface modulation system 400 is illustrated with respect to FIG. 4. The modulation system 400 may be applied using a device such as the user device 110 (FIG. 1). The modulation system may use an x-axis datum 410, an x-axis reference 415, a y-axis datum 420, and a y-axis reference 425. Modulation of the UI may consist of a static displacement by a number of units. For example if the UI is 1136×640 pixels an offset of negative 5 pixels might be used to indicate that a number of responses are received and remain unviewed. Time dependent modulation of a UI might indicate a notification. For example a modulation of ten pixels left and right of the x-axis datum moving at a rate of one pixel per 30 milliseconds might indicate that a positive opinion of an answer is received.

A user interface component such as the toggle control 405 might be modulated alone or in combination with an entire UI. For example, if a response is received from an audience or group indicated by the toggle control 405 the toggle control 405 might be spatially and/or temporally modulated to indicate such a notification. While a Cartesian coordinate system has been used for purposes of illustration in FIG. 4, no limitation is implied thereby. Any suitable mathematical representation of a UI may be used within the scope of the embodiments herein. While simple, linear one-dimensional displacements have been described with respect to FIG. 4 no limitation is implied thereby. Any modulation functions which can be represented within a display device associated with a user device might be used within the scope of the embodiments herein. For example, trapezoidal modulation, rotational modulation, linear, sinusoidal, and non-linear modulation of a position, brightness, and/or color assigned to a datum, a reference and/or a feature of a UI might be employed.

Using the method and systems described herein a notification is provided. A notification may be provided using a visual modulation of a user interface which is presented while an activity is performed. A visual modulation may be accompanied by audio and/or haptic modulations. A visual modulation may correspond to a specific action which may occur responsive to a posting. A posting may include a request for information or question or query. A posting may include a reply to a question and/or a reply to a reply. An event may cause a notification to be provided. A notification may include a persistence feature which may be removed responsive to a condition.

A notification may include modulation of an entire user interface. A notification may affect a specific user interface element. A notification may be modified based on a user interface which is to be modulated.

Modulation associated with a notification may be static. Modulation associated with a notification may be temporal. Modulation associated with a notification may be spatial. Modulation associated with a notification may indicate a type of response. Modulation associated with a notification may indicate a distribution channel associated with a request and a response. Modulation may include visual mimicry of a person performing an action associated with an event which activates a notification. Modulation may include a representation of a user associated with an event which has activated a notification.

In a system wherein a user may request responses of other users to a posting it is common that responses are presented according to a chronological order. For example, forums such as the AVS forum or DevShed present users with information of questions and answers in a sequential manner much as a dialogue would occur. Similarly social media services such as the Facebook® or Twitter® services may comprise sequential responses and/or postings.

Twitter and Facebook will typically indicate a source of a posting and permit a user to see responses to the posting in a separate page. Responses are presented chronologically so as to avoid issues with temporal disconnections wherein one user has responded to a comment of another and vice versa. An indicator of an originator of a posting as well as a responder to a posting may be provided with a response.

A sequential presentation of responses has proven to be effective, however there are some weaknesses associated with sequential presentation. It may be difficult to find a response of a particular individual within a long sequence of replies from a large number of users. Likewise, a response may relate to a prior posting by another user who is not identified in the response using for example “@UserName” or “#tagword” to identify a specific user and/or a topic of a posting and/or response. If a user is required to scroll through a large number of responses, locating particular responses and/or conversations within a thread may be difficult and/or unwieldy.

For these and other reasons a method and system for presenting responses would be greatly appreciated.

A system is provided whereby a user may submit a posting which may be distributed to potential responders. If a response is received a viewer may select a posting and may be provided with an identifier of a user and a response, which may provide immediate playback of a response when an identifier of the user becomes perceptible to a viewer. A response may be provided in various forms. A response which is a textual response may be presented as text and/or as audio information. A response may comprise an image, which may be rendered when an indicator of a responder becomes visible. A response may comprise video information.

Presentation of content of a response may be initiated sequentially. If a number of responses exceeds a number of indicators which can be provided to a user an initial response may be presented, and subsequent responses may be initiated automatically in a sequence based on an ordering of responses. For example, if six responses were received and only four indicators can be presented the first through fourth responses might be played sequentially, and then indicators would scroll to those of the fifth and sixth responses. Alternately, a ‘slide show’ of indicators of responses and responders might be presented to allow a user to non-linearly jump to a response. The selected response might auto-play in a similar manner. If a response has been previously viewed other responses may be given priority for playback.

A person selecting a posting or request may be able to filter responses. For example, responses may be selected based on a linked group of users (e.g., friends, family, location, affiliation, interest, etc.) which may reduce a number of responses. Likewise responses may be selected on behalf of a user. For example, responses associated with similar users may be provided for a given request or posting.

A request and/or a response may be presented to a viewer based on various criteria. A viewer may receive information of requests or responses based on interests of a viewer which may be explicitly expressed by a viewer and/or implied based on information of a viewer or user. For example a viewer may be presented with requests or postings which are related to tags and/or keywords which have been used by a viewer and/or which are associated with a posting. For example, keywords and/or tags such as “hash tags” which are indicated in a response and/or requests of a responder to a posting may be analyzed to select a posting.

A viewer may be presented with postings and/or requests based on a linkage between a viewer, a responder and a requester. For example a viewer may be provided with requests based on explicit relationships such as “following”, “follower” per the Twitter service, “friend”, “like”, etc. via Facebook, a group such as a Google+® group, etc. Similarly of a viewer mentions another person in a response or request, a linkage may be established as part of a graph of connections. More frequent mentions may increase a strength associated with a link.

Postings or requests may be presented to a viewer in various ways. In at least one embodiment, a viewer may be presented with an area for viewing requests selected based on links to others. A viewer may be presented with an area for viewing requests selected based on subject matter and/or frequency of response. Any combination of suitable criteria may be used to select requests and/or responses.

A system is provided which includes an editor system for obtaining a topic and submitting requests or questions, a distribution system receiving and distributing topics, requests, responses, advertisements, information and/or content, a database storing information of editors, responders, advertisers, advertisements, publishers, and other information, a website system receiving information and publishing content, responder systems receiving requests and providing responses and advertiser systems providing sponsored content and targeting information.

As used herein, a “request” or query or question means a request for information, products, and/or services. A request or query may include various types of media, and may be provided by any system which may establish communication with a server and/or other devices accessible via a network such as the internet.

A “user” is a person who submits a request and may receive any type of information responsive to a request. A user may be any person or entity. A “responder” is any person or entity which may provide a response to a request. A “viewer” is any person or entity which may request to view information of a request and/or response. A “response” may be any action which is received associated with a request such as a reply to a request, a reply to a reply, an opinion regarding a request and/or an item associated with a request. A person and/or entity may perform the roles of user, responder, and/or viewer as suitable for operation of the embodiments.

A responder may receive requests in various ways. A responder may elect to receive requests based on one or more categories, keywords or topics assigned to a responder. Profile information associated with a responder may be used to determine when a request is directed to a responder. A ranking of a responder may affect whether a request is directed to a responder. A social network graph of a responder may affect a probability that a responder may receive a request.

A viewer may receive information of requests in various ways. A viewer may become a responder based on permissions associated with a request, a response and/or a viewer. A request and/or response may include promotional materials such as advertisements. A viewer may receive promotional materials based on requests and responses which are provided to a viewer.

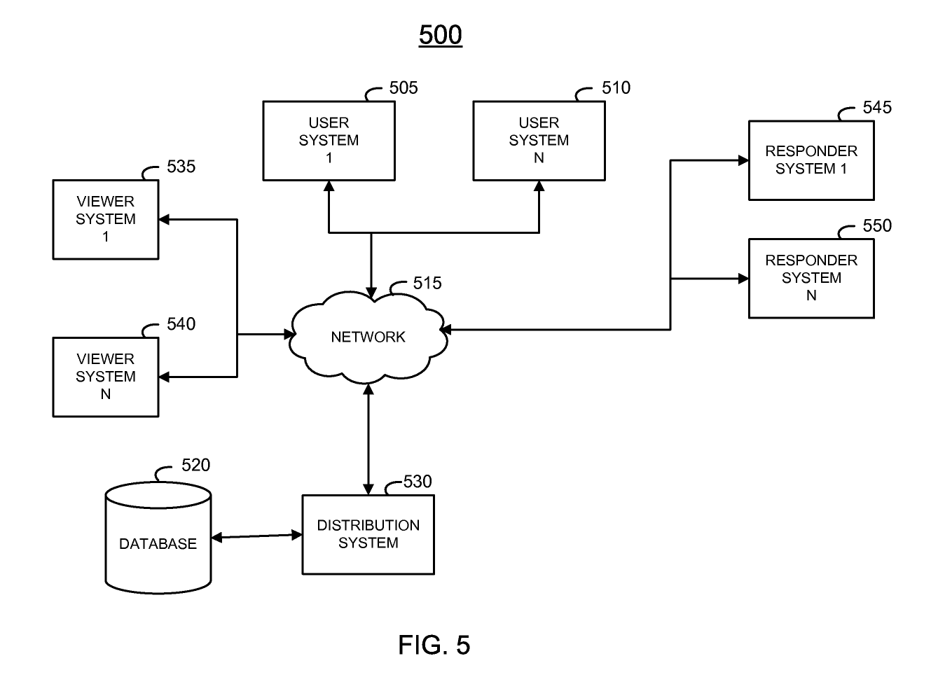

As illustrated in FIG. 5, system 500 includes user systems 505, 510, a network 515 such as the Internet, a distribution system 530, a database 520, which may comprise various records, viewer systems 535, 540, and responder systems 545, 550. A viewer system and/or a responder system may be operated by a user.

While only a few systems associated with a user, a responder and a viewer are depicted in FIG. 5 it is within the scope of the disclosure for multiple systems for a user, a responder and a viewer to be utilized. In particular it is envisioned that many user, responder and viewer systems may be implemented. The distribution system 530 may be a composed of many components as described further herein.

The network 515 may be a global public network of networks (i.e., the Internet) and/or may consist in whole or in part of one or more private networks and communicatively couples the user systems 505, 510, the viewer systems 535, 540, and the responder systems 545, 550 with the other components of the system such as the distribution system 530, and the database 520. The network 515 may include one or more wireless networks which may enable wireless communication between the various elements of the system 500. For example, the distribution system 530 may receive messages which may be routed via a wireless network controlled by a wireless service to the user systems 505, 510. A wireless service may receive messages from the responder systems 545, 550 via a wireless network which is a part of the network 515, and provide the messages to the distribution system 530 via an internet connection which is part of the network 515.

The distribution system 530 allows interaction to occur among the user systems 505, 510, the viewer systems 535, 540, and the responder systems 545, 550. For example, a request can be transmitted from the user system 505 to the distribution system 530, which may provide information obtained from the database 520, which may include an advertisement provided by the advertiser system 540 to the responder system 545. Any type of communication between users, responders, and/or viewers may be mediated and/or facilitated by the distribution system 530, and/or other elements of the system 500.

The distribution system 530 is communicatively coupled with the database 520. As will be described herein in further detail below, the database 520 includes data that is processed in association with operation of the embodiments. Although FIG. 5 illustrates the database 520 as a separate component of the system, the database 520 may be integrated with the distribution system 530. Further, the records maintained in the database 520 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 520 may reside in any suitable elements of the system 500. Any or all elements of the system 500 may include any or the entirety of the database 520.

The user systems 505, 510, the viewer systems 535, 540, the responder systems 545, 550, and the distribution system 530 may include equipment, software, systems and personnel required to send and/or receive messages between the user systems 505, 510, the viewer systems 535, 540, the responder systems 545, 550, and/or the distribution system 530 using the network 515. The database 520 includes information which may allow the distribution system 530 to establish communication between any or all of the elements of the system 500.

An user system, a viewer system, a responder system and/or a distribution system may be a desktop, portable, or tablet computer using an operating system such as Windows®, iOS®, Android®, etc., a mobile phone, a smart phone, a PDA, a server system, a landline phone, a specialized communication terminal, a terminal connected to a mainframe, or any other suitable communication hardware and/or system. The distribution system 530, a user system, a viewer system and/or a responder system may include one or more servers, computers, etc. For example, servers such as the PowerEdge® 2900 by Dell, or the BladeCenterJS22 by IBM, or equivalent systems might be used to implement elements of the distribution system 530. The distribution system 530 may utilize an operating system (OS) such as Microsoft Windows XP®, Linux, iOS®, Android®, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, publisher systems, advertiser systems, responder systems and/or to implement the distribution system 530.

A user may be identified by the distribution system 530. When a user system accesses the distribution system 530 a user may be identified based on security information provided to the distribution system 530. A user may provide information of others which are associated with a user. Contact information provided by a user may be used to determine a graph of connections between a user and other users.

A user may be required to register with the distribution system 530. As part of a registration process, at least one communication method is associated with a user. In at least one embodiment, a user may register with the distribution system 530 and establish a username and password which are associated with the user. A user may login to the distribution system 530 using a web browser functionality of the user system 510 in order to communicate with the distribution system 530. A user may login to the distribution system using credentials associated with other systems such as email, a social network and/or other forms of Single Sign On (SSO). One or more identifiers may be assigned to a user and may be used to identify content associated with a user. A user may provide profile information such as personal information, geographic, background, affiliation, demographic, interest, category, etc. information.

A responder may be required to register with the distribution system 530. As part of a registration process, at least one communication method is associated with a responder. In at least one embodiment, a responder may register with the distribution system 530 and establish a username and password which are associated with the responder. A responder may login to the distribution system 530 using a web browser functionality of the responder system 545 in order to communicate with the distribution system 530. One or more identifiers may be assigned to a responder and may be used to identify content associated with a responder. A responder may provide profile information such as personal information, geographic, background, affiliation, demographic, interest, category, etc. information. A request may be directed to a responder based on any information associated with a responder. A responder may elect to block requests based on factors such as content, originator, etc. A responder may provide information required to provide payment to a responder.

When a responder is registered with the distribution system 530 the responder may have access to content available from the distribution system 530. This may include sponsored content, data indicated in the database 520, requests of users, topics, etc. A responder may have access privileges based on factors such as experience of the responder, ratings of responses of a responder, etc.

A viewer may be required to register with the distribution system 530. As part of a registration process, at least one communication method is associated with a viewer. In at least one embodiment, a viewer may register with the distribution system 530 and establish a username and password which are associated with the advertiser. A viewer may login to the distribution system 530 using a web browser functionality of the advertiser system 535 in order to communicate with the distribution system 530.

When a viewer is registered with the search system 530 a viewer may have access to data available from the distribution system 530. This may include requests, responses, advertisements, and/or information indicated in the database 520. A viewer may access the distribution system via an API which may be used to identify a viewer. A viewer may be prevented from responding to requests if a viewer has not provided suitable credentials to the distribution system 530.

Records may be maintained in the database 520 which may be used to record the status of various items. Such records may be used to aid the targeting of content provided by advertisers, track activities of users, determine usage history of requesters, responders, viewers, etc. For example, a user may submit a request and might receive information of responses to a request, which may be recorded in the database 520. Similarly, the database may include records of activities of viewers and responders.

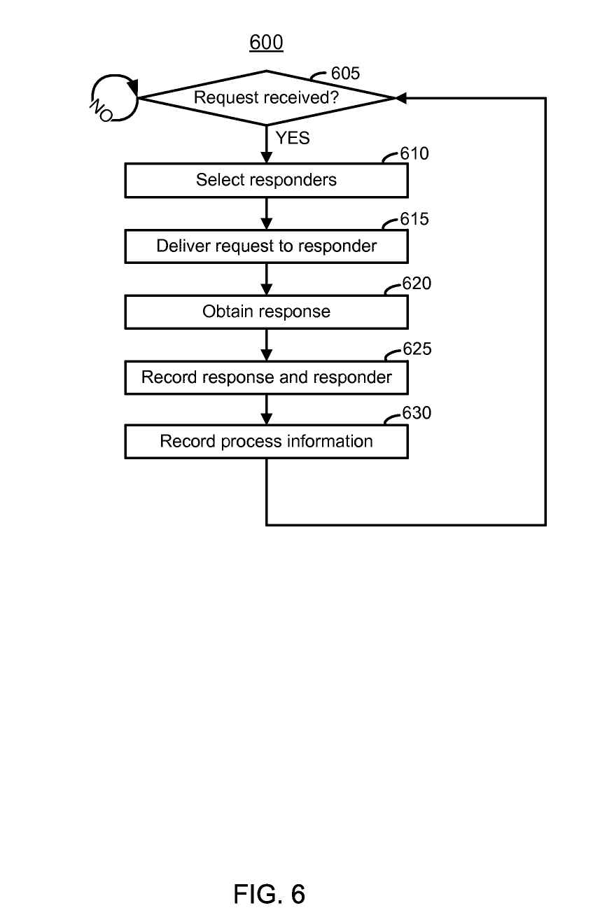

As illustrated in FIG. 6, a process 600 for responding to a request is provided. The process 600 may be performed in whole or in part by any suitable element of the system 500 (FIG. 5). In at least one embodiment, the process 600 is operative on a server associated with the distributor system 530.

In operation 605 (FIG. 6) a determination is made as to whether a request is received. If it is determined in operation 605 that a request is not received, control remains at operation 605 and process 600 continues. If it is determined in operation 605 that a request is received, control is passed to operation 610 and process 600 continues.

The determination in operation 605 may be made using various criteria. In at least one embodiment, if a message is received at a system associated with the distribution system 530 (FIG. 5), it may be determined that a request is received. For example if a message is received from an application or “App” operative on a user device it may be determined that a request is received. Any type of message may be received which may indicate that a request is received. For example, reception of an SMS message, a mobile web message, a message from an App, etc., may be used to determine whether a request is received. If information associated with a request is modified and/or augmented it may be determined that a request is received.

In operation 610 responders are selected. Selection of responders may be performed based on various criteria. A ranking of a responder based on previous responses by a responder to request of a user may be used to select a responder. A ranking of a responder based on a response to a request associated with a subject matter, a location, etc., of a request may be used to select a responder. Temporal information associated with a responder such as response urgency, login status, requests submitted, etc., may affect a ranking of a responder which may be used to select a responder. Control is passed to operation 615 and process 600 continues.

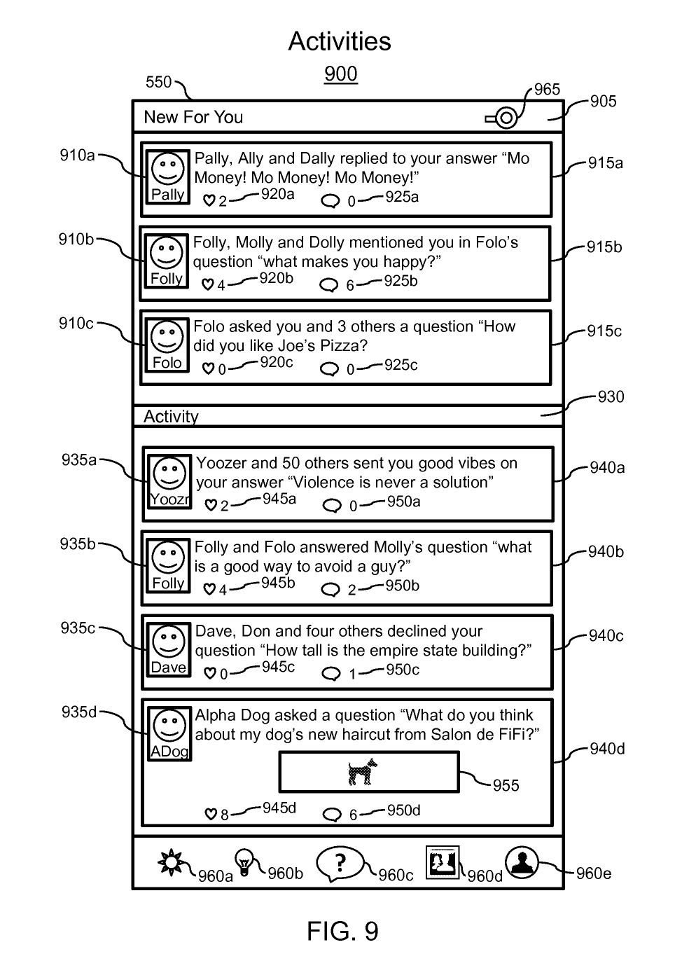

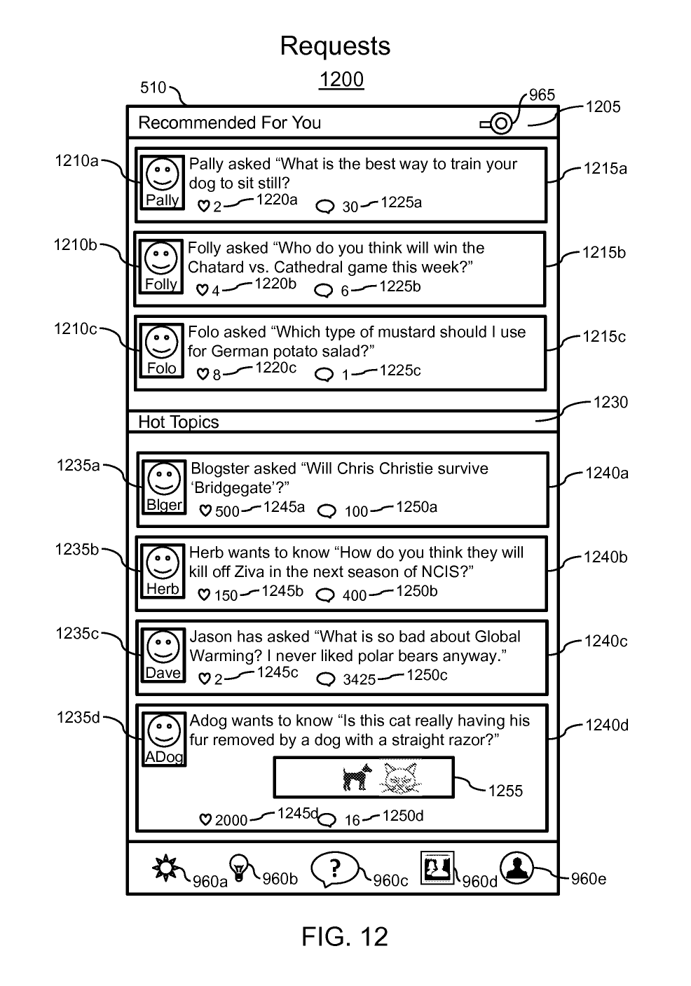

In operation 615, a request is delivered to a responder. Additional information of a request may be provided to a responder, such as responses of others regarding a request, information of a user or requester associated with a request, an opinion of other users, etc. Typically a request may be delivered to a plurality of responders. A request may be presented to a responder in an order based on a ranking of the request for the responder. A notification of a request may be provided to a responder. A request may be provided to a responder based on preferences indicated by a responder. A request may be presented to a responder based on a number and/or frequency of responses associated with a request and/or a responder associated with a request. For example, a request with a lower number of responses may be more likely to be provided to a responder. Exemplary interfaces for delivering a request are illustrated in FIG. 9 and FIG. 12. Control is passed to operation 620 and process 600 continues.

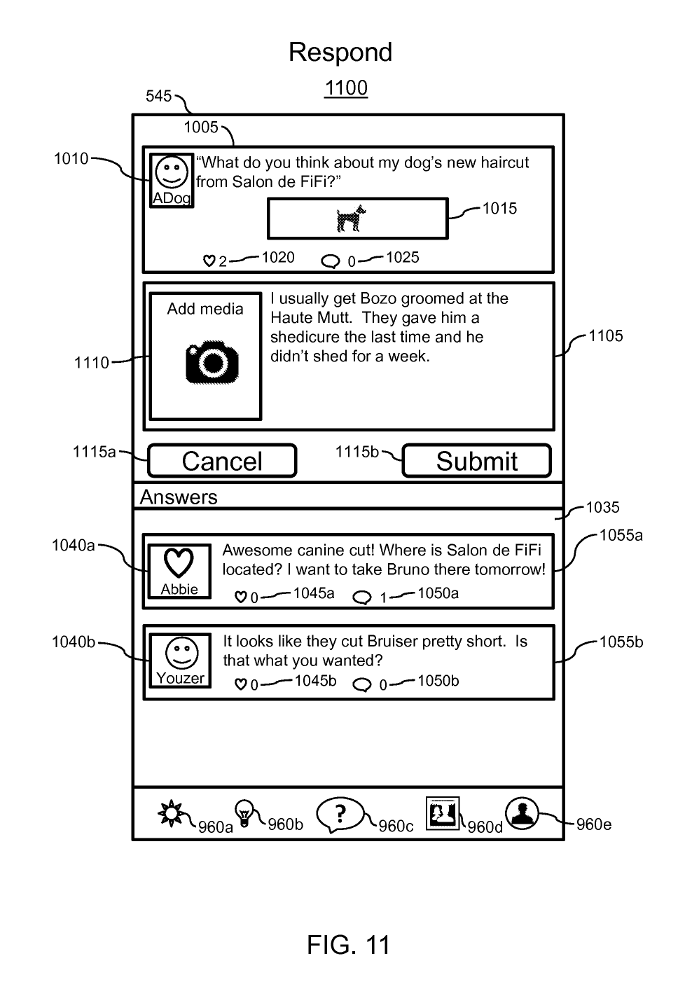

In operation 620 a response is obtained. Any number of responses may be obtained. Absence of a response may constitute an implicit response. An explicit decline of a request may be a response. A response may include media of any suitable type such as audio, text, video, images, URL's, etc. A response may comprise an opinion regarding any item associated with a request. An exemplary interface for obtaining a response is illustrated in FIG. 11. Control is passed to operation 625 and process 600 continues.

In operation 625 a response and a responder is recorded. Content of a response, information of a responder associated with a response, temporal information of a response, etc. may be recorded in the database 520. Control is passed to operation 630 and process 600 continues.

In operation 630, process information is recorded. Information of a request, a user, a responder, a response, an advertisement, etc., a rating, a ranking, etc. may be recorded. In at least one embodiment, process information is recorded in the database 520 (FIG. 5). Control is passed to operation 605 and process 600 continues.

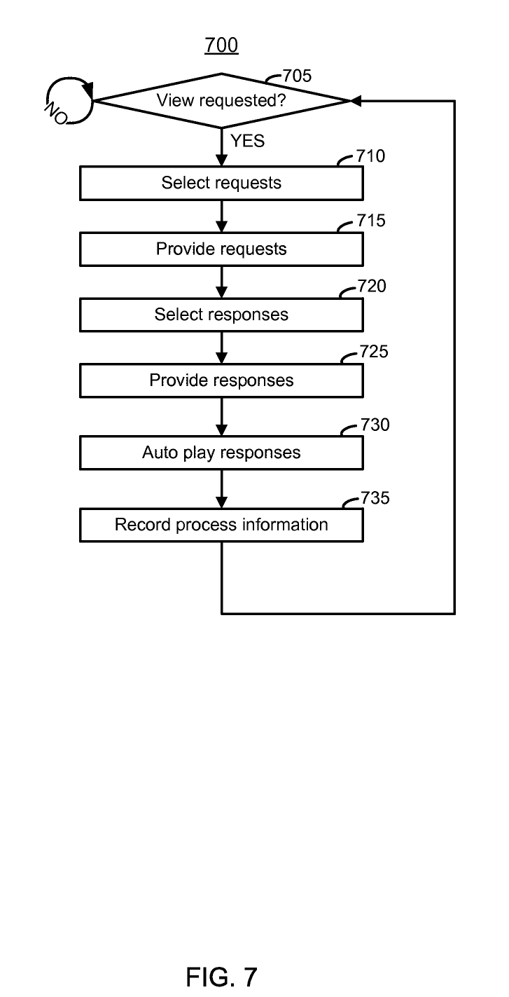

As illustrated in FIG. 7, a process 700 for responding to a view request is provided. The process 700 may be performed in whole or in part by any suitable element of the system 500 (FIG. 5). In at least one embodiment, the process 700 is operative on a server associated with the distributor system 530.

In operation 705 (FIG. 7) a determination is made as to whether a view is requested. If it is determined in operation 705 that a view is not requested, control remains at operation 705 and process 700 continues. If it is determined in operation 705 that a view is requested, control is passed to operation 710 and process 700 continues.

The determination in operation 705 may be made using various criteria. In at least one embodiment, if a message is received at a system associated with the distribution system 530 (FIG. 5), it may be determined that a request is received. For example if a message is received from an application or “App” operative on a viewer device it may be determined that a view is requested. Any type of message may be received which may indicate that a view is requested. For example, reception of an SMS message, a mobile web message, a message from an App, etc., may be used to determine whether a view is requested. If information associated with a request is modified and/or augmented it may be determined that view is requested.

In operation 710 requests are selected. Request may be selected based on content of a view request. For example, requests may be selected which are associated with a user, a category, a responder, a keyword or category, a hash tag, etc. which is indicated in a view request. Requests may be selected based on an origin or source of a view request. For example, information of a user, an entity, etc., which may originate a view request may be used to select a request based on a ranking of requests based on an origin. A social graph associated with an origin may affect whether a request is selected. For example, if an origin of a request frequently communicates with a requester and/or a responder associated with a request, it may be more probable that a request will be selected. Any combination of criteria may be used to select a request. For example, a request with responses which are more recent may be more likely to be selected than a request which has responses which are older or requests which have a higher number of responses from users associated with a responder may have an increased probability or likelihood of being selected. Control is passed to operation 715 and process 700 continues.

In operation 715, requests are provided. Requests may be provided as indicators of any sort. A request may be provided including any suitable media. An indicator of a request may be provided in an order based on a ranking of a request. For example, chronological, activity, topic, relevance, responders, etc. associated with a request may affect an order in which an indication of a request may be presented. Control is passed to operation 720 and process 700 continues.

In operation 720 responses are selected. Any number of responses may be selected. Responses may include media of any type. Responses which include interactive media may be preferentially selected based on a probability and/or a ranking. Responses to responses may be selected. Responses may be selected based on content of responses such as hashtags, keywords, etc. Responses may be selected based on relevance to a request, ratings, originators of opinions, number of opinions, etc. Control is passed to operation 725 and process 700 continues.

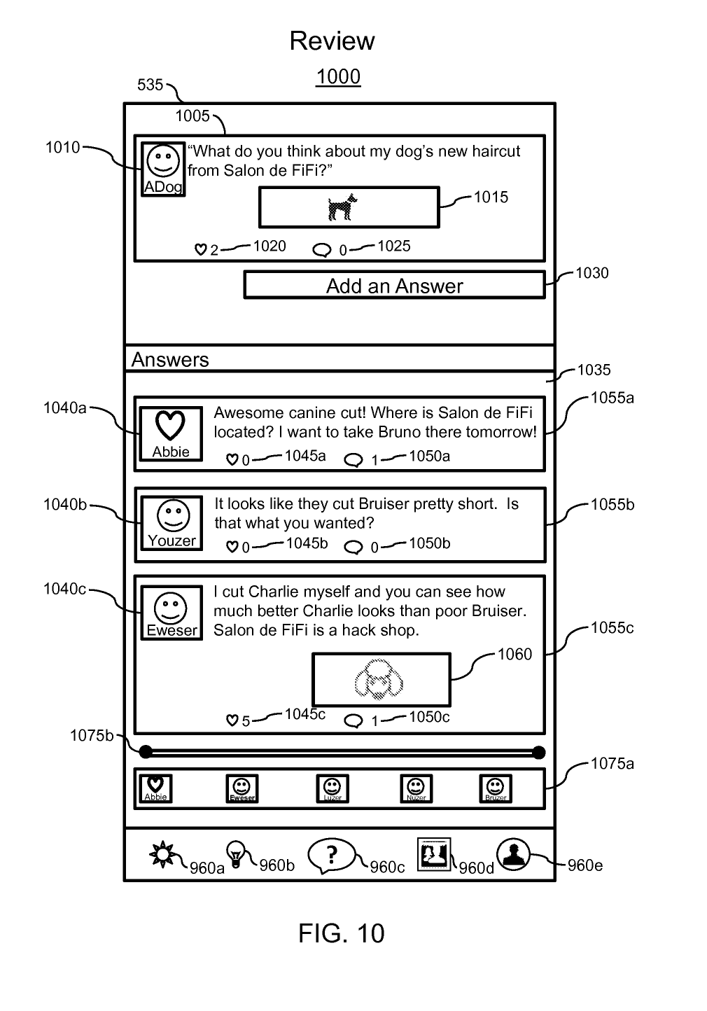

In operation 725 responses are provided. Responses may be provided in any suitable manner. An exemplary user interface for providing responses is illustrated in FIG. 10. Any number of responses may be provided in any order. Responses may be provided based on age, viewing status, popularity, etc. Control is passed to operation 730 and process 700 continues.

In operation 730 responses are autoplayed. For example, when a particular request is presented, responses may be played sequentially as with a conversation. An oldest response that is ‘fresh’ (i.e., has not been reviewed by a viewer) may be presented first. A contextual order may be used for autoplay (i.e., to initiate playback without explicit user selection of a playback control). For example, if a reply to a response to a request is received, content of the request, the response and the reply may be autoplayed. If a user navigates to a response, a response may autoplay responsive to the navigation. If a response associated with a request is viewed, or if a response associated with skipped, a ranking of a response for a viewer may be decreased or increased. Control is passed to operation 735 and process 700 continues.

In operation 735, process information is recorded. Information of a request, a user, a responder, a response, an advertisement, etc., a rating, a ranking, etc. may be recorded. In at least one embodiment, process information is recorded in the database 520 (FIG. 5). A status of a response such as viewed, declined, skipped, etc. with respect to a viewer may be recorded. Control is passed to operation 705 and process 700 continues.

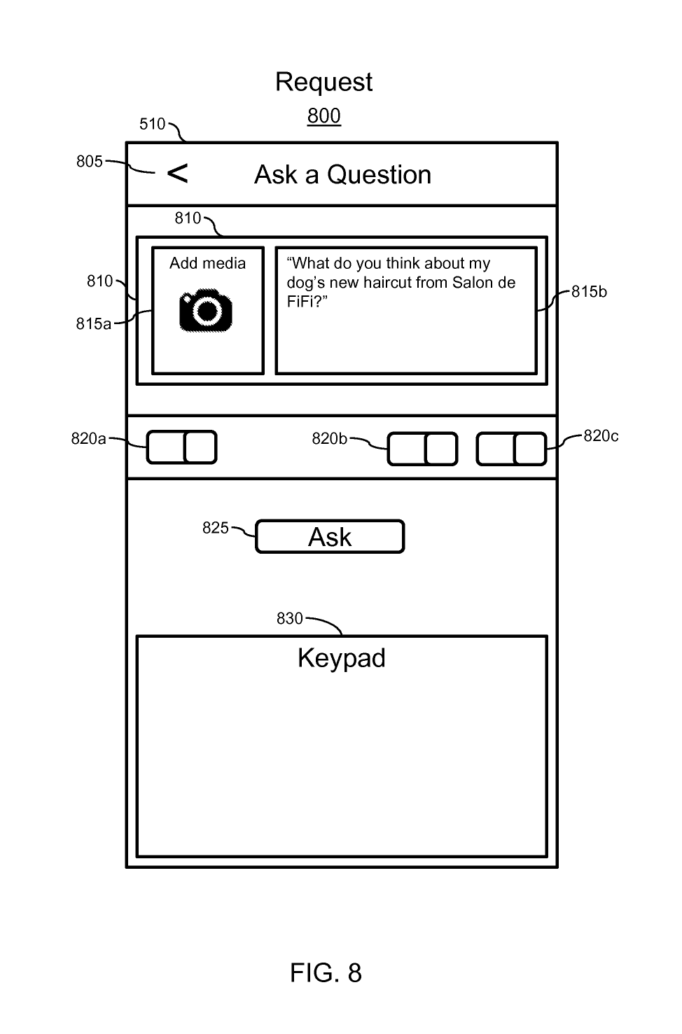

As illustrated in FIG. 8 an exemplary GUI 800 for submitting a request is provided. The GUI 800 may be provided using a device such as the user system 510 (FIG. 5). The GUI 800 may include a back control 805, a query area 810, query content controls 815a-b, query direction controls 820a-c, a submit control 825, and user input controls 830.

The back control 805 may be used to cause a prior GUI to be provided. The query area 810 may provide controls for creating a request. The query content control 815a may be used to associate media with a request. For example an imaging device of the user device 510 (FIG. 5) may be used to acquire an image, audio and/or video associated with a request when the query content control 815a is activated. The query content control 815b may be used to indicate textual information associated with a request. Activation of the query content control 815b may cause the user input controls 830 to be provided. While a few query content controls are illustrated in FIG. 8, any number of query content controls associated with various types of media may be provided.

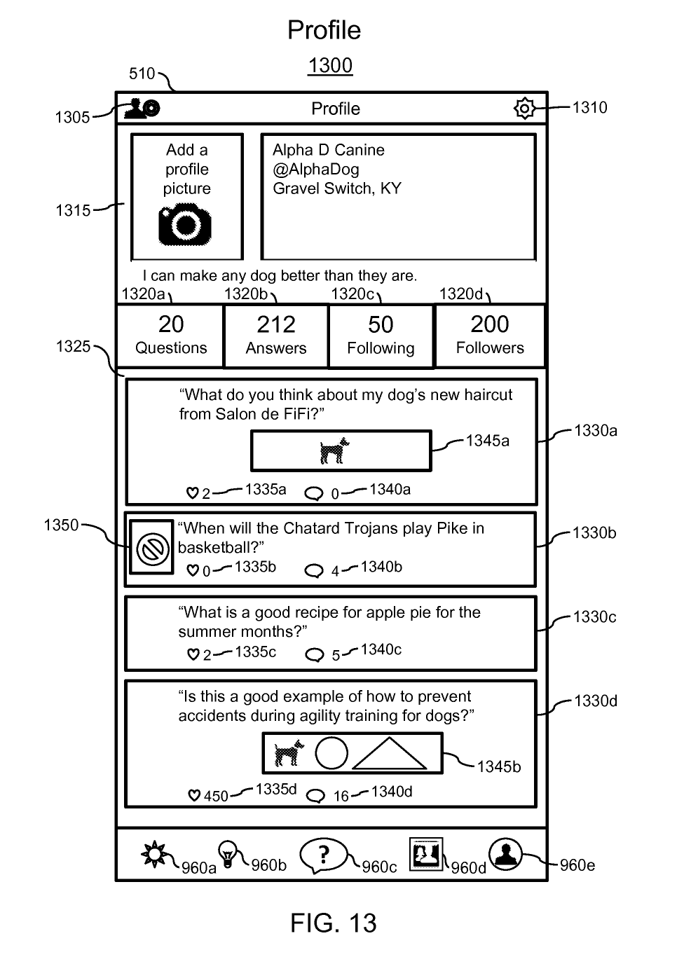

The query direction controls 820a-c may be used to indicate how a request is to be presented. The query direction control 820a may be used to present or suppress an indicator of a user submitting a request when the request is presented. For example if the query content control 820a is active, a profile image and name indicated in a profile as illustrated with respect to FIG. 13 may be provided when a request is presented. The query direction controls 820b and 820c may determine whether a request is directed to an audience. For example, activation or inactivation of the query direction control 820b may cause a request to be distributed to a social network such as FaceBook, LinkedIn® or Twitter service subscribers. The submit control 825 may be activated to submit a request for distribution.

An exemplary activity GUI 900 for presentation of requests is illustrated in FIG. 9. The activity GUI 900 may be provided using a device such as the responder system 550 (FIG. 5). The activity GUI 900 may be presented responsive to activation of a control provided for that purpose. The activity GUI 900 may include a selected response area 905, selected request indicators 920a-c, a raw request area 930, raw request indicators 940a-d, interface selection controls 960a-e, and a request filter control 965.

The selected request area 905 may be used to provide information of requests which have been chosen based on implicit criteria and/or filtering. For example, if a responder has chosen to view only requests with activity in the last 24 hours, those requests might be presented in the selected response area 905. The selected request indicators 915a-915c may be used to indicate information of selected requests. For example the selected request indicator 915b provides information regarding the request “what makes you happy”. Selected request requester indicators 910a-c, may be used to provide information of a requester associated with a selected request. For example, the selected request requester indicator 910a may indicate that ‘Pally’ has submitted a reply to a response of a user of the GUI 900. Selected request opinion indicators 920a-920c may be used to indicate information of opinions associated with a selected request. For example, the selected request opinion indicator 920a may indicate that two user have expressed a positive opinion regarding the request indicated in the selected request indicator 915a. Selected request reply indicators 925a-925c may be used to indicate information of responses associated with a selected request. For example, the selected request reply indicator 920c may indicate that no users have provided a reply regarding the request indicated in the selected request indicator 915a.

The raw response area 930 may be used to provide information of requests which have been chosen based on limited criteria. For example any request which has received activity may be presented in the raw response area 930 in chronological order. The raw request indicators 940a-940d may be used to indicate information of raw requests. For example the raw request indicator 940a provides information regarding the request with a response “Violence is never a solution”. Raw request requester indicators 935a-935d may be used to provide information of a requester associated with a selected request. For example, the raw request requester indicator 935b may indicate that ‘Folly’ has submitted a reply to the request “what is a good way to avoid a guy”. Raw request opinion indicators 945a-945c may be used to indicate information of opinions associated with a raw request. For example, the raw request opinion indicator 945d may indicate that eight user have expressed a positive opinion regarding the request indicated in the selected request indicator 940d. Raw request reply indicators 950a-950d may be used to indicate information of responses associated with a raw request. For example, the raw request reply indicator 920c may indicate that one user has provided a reply regarding the request indicated in the raw request indicator 940c.

A user may be able to navigate through content of the selected request area 905 and/or the raw response area 930, which may include a media window 955. If the media window 955 is present, presentation of content of the media window 955 may automatically be initiated in an order in which the media window 950 appears. Content of the selected request area 905 and/or the raw response area 930 may be removed and/or scrolled after playback is completed.

The interface selection controls 960a-960e may be used to select a user interface. Activation of the interface selection control 960b may cause a GUI such as that depicted in FIG. 12 to be provided. Activation of the interface selection control 960c may cause a GUI such as the GUI 800 depicted in FIG. 8 to be provided. Activation of the interface selection control 960d may cause the GUI 900 to be provided. Activation of the interface selection control 960c may cause a GUI such as that depicted in FIG. 13 to be provided. Any number of interface selection controls may be provided and or suppressed as required to operate the embodiments. The request filter control 965 may be used to select request based on criteria such as a user name, user group, keyword, hashtag, etc.

An exemplary viewing GUI 1000 for presentation of responses is illustrated in FIG. 10. The reviewing GUI 1000 may be provided using a device such as the responder system 550 (FIG. 5). The reviewing GUI 1000 may be presented responsive to activation of a control provided for that purpose. The reviewing GUI 1000 may include a request information area 905, selected response indicator area 1035, and response presentation controls 1075a-1075d.

The request information area 1005 may include a request user ID 1010 which may provide information of a user associated with a request, a request media indicator 1015 which may comprise information of media associated with a request, a request opinion indicator 1020 which may indicate opinions associated with a request, and a request response indicator 1025 which may be used to indicate information of a response or answer associated with a request. A number of responses, a number of unviewed responses, etc. may be indicated using any suitable means such as color underlining, etc.

The selected response indication area 1035 may include selected response indicators 1055a-1055c which may indicate content of a response or reply. Content of selected response indicators may be determined by a process such as that described herein with respect to FIG. 7. Selected response user indicators 1040a-1040c may indicate information of a user associated with a response. Selected response opinion indicators 1045a-1045c may be used to indicate information of opinions associated with a response. Selected response reply indicators 1050a-1050c may be used to indicate information of answers or replies associated with a response. The selected response indication area may include a response media indicator 1060. When the response media indicator is presented in the selected response indication area playback of media associated with the response media indicator may be initiated and/or added to a queue for playback.

The response presentation controls 1075a-1075b may be used to access content of responses. For example, ‘thumbnails’ of a responder associated with a response may be provided which may permit non-linear access to content of responses without scrolling as the response presentation control 1075a. Similarly a ‘slider’ control may be provided to permit rapid visual search of content of responses without scrolling or swiping as in the response presentation control 1075b. Activation of a response presentation may provide preview information of responses and/or may permit a change of playback sequence. Media of a response may be converted from static to dynamic form such as conversion of audio to text for purposes of playback. Any content associated with a response may be included in a playback sequence. Activation of the answer control 1030 and/or the response indicators 1055a-1055c may cause a GUI such as the GUI 1100 depicted in FIG. 11 to be provided.

An exemplary response GUI 1100 for responding to a request is illustrated in FIG. 11. The response GUI 1100 may be provided using a device such as the responder system 545 (FIG. 5). The response GUI 1100 may be presented responsive to activation of a control provided for that purpose. The response GUI 1100 may include the request information area 1005, the selected response indicator area 1035, the interface selection controls 960a-960e, a response indicator 1105, a response media indicator 1110, and response submission controls 1115a-1115b.

The response indicator 1110 may be used to provide textual information regarding a response. The response media indicator 1110 may be used to provide information of media such as audio, video, images, etc. associated with a response. The response submission control 1115a may be used to cancel a response. The response submission control 1115b may be used to submit a response associated with a request and/or an answer.

An exemplary request GUI 1200 for presentation of requests is illustrated in FIG. 12. The request GUI 1200 may be provided using a device such as the responder system 550 (FIG. 5). The request GUI 1200 may be presented responsive to activation of a control provided for that purpose. The request GUI 1200 may include a personal request area 1205, and a popular request area 1230.

The personal request area 1205 may be used to provide information of requests which have been chosen for a responder based on a responder network. For example, if a request has been submitted by a user associated with a responder, the request may be presented in the personal request area 1205. The personal request indicators 1215a-1215c may be used to indicate information of personal requests. For example the personal request indicator 1215b provides information regarding the request “Who do you think will win the Chatard vs. Cathedral game this week?” Personal request requester indicators 1210a-c, may be used to provide information of a requester associated with a personal request. For example, the personal request requester indicator 1210a may indicate that ‘Pally’ has submitted the request indicated in the personal request indicator 1215a. Personal request opinion indicators 1220a-1220c may be used to indicate information of opinions associated with a personal request. For example, the personal request opinion indicator 1220a may indicate that two user have expressed a positive opinion regarding the request indicated in the personal request indicator 1215a. Personal request reply indicators 1225a-1225c may be used to indicate information of responses associated with a personal request. For example, the personal request reply indicator 1220c may indicate that a user has provided a reply regarding the request indicated in the selected request indicator 1215a.

The popular request area 1230 may be used to provide information of requests which have been chosen based on broad criteria. For example any request which has received a predetermined level of activity, is associated with a category, or otherwise selected from a group of more than a predetermined number of requests associated with the criteria may be presented in the popular request area 1230 in an order based on ranking. The popular request indicators 1240a-1240d may be used to indicate information of popular requests. For example the popular request indicator 1240a provides information regarding the request “Will Chris Christie survive ‘Bridgegate’?” Popular request requester indicators 1235a-1235d may be used to provide information of a requester associated with a popular request. For example, the popular request requester indicator 1235b may indicate that ‘Herb’ has submitted the request “How do you think they will kill off Ziva in the next season of NCIS?” Popular request opinion indicators 1245a-1245c may be used to indicate information of opinions associated with a popular request. For example, the popular request opinion indicator 1245d may indicate that two thousand users have expressed a positive opinion regarding the request indicated in the popular request indicator 1240d. Popular request reply indicators 1250a-1250d may be used to indicate information of responses associated with a popular request. For example, the popular request reply indicator 1220c may indicate that three thousand four hundred twenty-five users have provided a reply regarding the request indicated in the popular request indicator 1240c.

A user may be able to navigate through content of the personal request area 1205 and/or the popular request area 1230, which may include a media window 1255. If the media window 1255 is present, presentation of content of the media window 1255 may automatically be initiated in an order in which the media window 1250 appears. Content of the personal request area 1205 and/or the popular request area 1230 may be removed and/or scrolled after playback is completed.

As illustrated in FIG. 13 an exemplary profile GUI 1300 for managing requests, answers and connections is provided. The profile GUI 1300 may be provided using a device such as the user system 510 (FIG. 5). The profile GUI 1300 may include a person finder control 1305 which may be used to obtain information of other users. A personal information management control 1310 may be used to access and/or modify personal data such as password, etc. A profile information area 1315 may be used to provide information such as an image of a user, contact information, a mission statement, etc. Viewing controls 1320a-1320d may be used to control information presented in a review area 1325 and to provide information of requests, responses, persons being monitored by and persons monitoring a user indicated in the profile information area 1315. The viewing control 1320a may be activated to cause information of requests submitted by a user indicated in the profile information area 1315 to be presented in the review area 1325. The viewing control 1320b may be activated to cause information of responses submitted by a user indicated in the profile information area 1315 to be presented in the review area 1325. The viewing control 1320c may be activated to cause information of users monitored by a user indicated in the profile information area 1315 to be presented in the review area 1325. The viewing control 1320d may be activated to cause information of users monitoring a user indicated in the profile information area 1315 to be presented in the review area 1325.

Item indicators 1330a-1330d may provide information of items selected to be indicated in the review area 1325. Item opinion indicators 1335a-1335d may provide information of opinions regarding an item. Item response indicators 1340a-1340c may provide information of responses associated with an item. Item media indicators 1345a-1345b may indicate media which may be presented as and when the item media indicators 1345a-1345b are presented in the review area 1325. An item anonymity indicator 1350 may be used to indicate that an item was submitted anonymously.

Using the methods and systems described herein information of items associated with requests and responses may be provided to a viewer. A request associated with a linear and/or diverging group of responses may be created. Requests may be received and distributed to requesters, responders and/or viewers. Requests and/or responses may be presented to a user, responder and/or viewer based on criteria such as subject matter, expertise, responsiveness, presence, a social graph and/or any combination of factors.

A person may receive information of responses and/or requests which may be related. Media indicated in an item such as a request, response, advertisement, etc. may be initiated when an item is presented to a viewer. A viewer may be provided with controls to allow random access to media and/or items based on a visual index of the items. Items may be presented in an order based on the presence or absence of a type of media associated with an item.

A system and method of presentation of peer generated content is described. A request is submitted by a user and may receive various responses from a group of users. Requests and/or responses may be selected and presented to a viewer request based on various elements of a request and response group.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method comprising:
receiving a request from a source;
procuring an action related to the request;
notifying the source of the request of the action by modulation of a user interface at the source.

2. The method of claim 1 further comprising:
obtaining a message to be delivered to a destination as the request;
procuring the action from the destination; and
performing the modulation based on whether the user interface is associated with operation of a pre-determined software component.

3. The method of claim 1 further comprising:
including a temporal and spatial component in the modulation of the user interface.

4. The method of claim 1 further comprising:
assigning modulation patterns to actions including the action; and
executing a pattern of modulation associated with the action as the notifying.

5. The method of claim 1 further comprising:
performing a spatial modulation while persisting a prior context of the user interface.

6. The method of claim 5 further comprising:
performing the spatial modulation based on a status of a user associated with the source.

7. The method of claim 1 further comprising:
performing a spatial visual modulation as at least one of translation, scaling, rotation and distortion of geometry associated with the user interface.

8. The method of claim 7 further comprising:
including a temporal component in a spatial component of the modulation.

9. The method of claim 8 further comprising:
returning the user interface to an initial condition after a pre-determined time interval.

10. The method of claim 8 further comprising:
returning the user interface to an initial condition when an event associated with the notification occurs.

11. The method of claim 1 further comprising:
mimicking a characteristic of a person performing the action using a spatial component of the modulation.

12. The method of claim 1 further comprising:
mimicking a characteristic of a person performing the action using a spatial modulation and a corresponding audible tone.

13. The method of claim 2 further comprising:
providing an avatar assigned to the destination associated with the action as a part of the notification.

14. The method of claim 2 further comprising:
determining a spatial modulation component based on a distribution channel associated with the request and the destination.

15. The method of claim 1 further comprising:
applying a spatial modulation to a user interface element selected based on the user interface and a distribution channel associated with the request and the destination.

16. The method of claim 1 further comprising:
presenting an alternate identifier of a user related to the action when an identifier of the user is not visible to the viewer; and
initiating playback of the response when the alternate identifier is selected.

17. A non-transitory computer readable storage medium storing therein a program for causing a computer to execute an operation, comprising:
receiving a request from a source;
procuring an action related to the request;
notifying the source of the request of the action by modulation of a user interface at the source.

18. A system, comprising:
a source device comprising memory, a processor and a display, sending a request, receiving an action responsive to the request and informing a user of the source device of the action by visual modulation of a user interface of the source device.

19. The system of claim 18 further comprising:
a request server device receiving the request, providing the action, and specifying a parameter of the modulation based on the action.

20. The system of claim 18 further comprising:
the source device performing the modulation based on geometric distortion or displacement of the user interface.
